(19) United States
(12) Patent Application Publication
(10) Pub. No.: US 2015/0153901 A1
(43) Pub. Date: Jun. 4, 2015

(54) SCAN METHOD FOR A CAPACITIVE TOUCH PANEL

(71) Applicant: ELAN MICROELECTRONICS CORPORATION, HSINCHU (TW)

(72) Inventors: Chia-Mu Wu, Taipei City (TW); Tse-Lun Hung, Taipei City (TW); Shun-Yi Chen, Taoyuan City (TW); Chin-Cheng Lu, Tainan City (TW); Cheng-Yu Chen, Tainan City (TW)

(73) Assignee: ELAN MICROELECTRONICS CORPORATION

(21) Appl. No.: 14/616,671

(22) Filed: Feb. 7, 2015

Related U.S. Application Data
(62) Division of application No. 13/552,459, filed on Jul. 18, 2012.

(30) Foreign Application Priority Data
Feb. 16, 2012 (TW) 101101997

(51) Int. Cl. G06F 3/041; G06F 3/044

(52) U.S. Cl. CPC G06F 3/0418; G06F 3/044

(57) ABSTRACT

A scan method for a capacitive touch panel has steps of performing a relatively small first number of estimation scans on multiple sensing lines of a capacitive touch panel and recording results of the estimation scans, marking the sensing lines meeting a predetermined condition according to the results of the estimation scans, and performing a relatively large second number of practical scans on the marked sensing lines. Given the first-stage estimation scans and the second-stage practical scans, the sensing lines possibly touched by a touch object can be rapidly identified and marked, and the second-stage practical scans are performed on the marked sensing lines. Accordingly, noises and errors can be effectively reduced, accurate scan can be ensured, and higher frame rate can be achieved.

### CROSS-REFERENCE TO RELATED APPLICATIONS

This application is a divisional application of U.S. patent application filed on Jul. 18, 2012 and having application Ser. No. 13/552,459, the entire contents of which are hereby incorporated herein by reference.

### BACKGROUND OF THE INVENTION

1. Field of the Invention

The present invention relates to a scan method for a capacitive touch panel and more particularly to a scan method for a capacitive touch panel capable of suppressing noise and enhancing frame rate.

2. Description of the Related Art

The signal detection methods of capacitive touch panels can be generally classified as a mutual-capacitance scanning approach and a self-capacitance scanning approach. With reference to FIG. 10, the self-capacitive scanning approach scans sensing lines first in a first-axis direction and then in a second-axis direction. For example, multiple Y-axis sensing lines Y₁˜Yₙ are scanned first, and then multiple X-axis sensing lines X₁˜Xₘ are scanned, or the other way around. When being scanned, each sensing line is applied with a driving signal before it is sensed.

The mutual-capacitance sensing approach applies the driving signals to the sensing lines in the first-axis direction and then senses the sensing lines in the second-axis direction. With reference to FIG. 11, suppose that the Y-axis sensing lines Y₁˜Yₙ are applied with the driving signals first, all the X-axis sensing lines X₁˜Xₘ are then sensed. Alternatively, suppose that the X-axis sensing lines X₁˜Xₘ are applied with the driving signals first, all the Y-axis sensing lines Y₁˜Yₙ are then sensed.

No matter if the self-capacitance sensing approach or the mutual-capacitance sensing approach is used, when a capacitive touch panel has a touch object thereon, such as a user's finger or a stylus in contact with the surface of the capacitive touch panel, the position of the touch object can be determined according to a capacitance value obtained from the sensed capacitance variation of the sensing lines.

However, the accuracy of identifying touch objects on capacitive touch panels is reduced by surrounding noises, such as AC noises, LCM noises and the like. To effectively lower the noise interference against touch panels, one feasible method in the past is to perform a default number of scans on each sensing line and take an average of the sensing values obtained from the default number of scans. The average value is compared with a preset sensing threshold, and if greater, it represents that a touch object may touch the sensing line.

Suppose that each sensing line is scanned 32 times according to a setting, given the self-scan method in FIG. 10 as an example, all sensing lines in a frame including Y₁˜Yₙ and X₁˜Xₘ must be scanned 32 times before the frame is outputted. Similarly, given the mutual-scan method in FIG. 11 as an example, all the Y-axis sensing lines Y₁˜Yₙ must be applied with driving signals before all the X-axis sensing lines X₁˜Xₘ are sensed 32 times.

Although the approach of scanning entire sensing lines more times can mitigate the influence of noise, the tradeoff is a lower frame rate, especially when the touch panels are large in size. This is because large-size touch panels have more sensing lines and the frame rate can be noticeably reduced. From the perspective of users' operation, users inevitably experience the discomfort arising from the slowness in response to touch events on touch panels.

### SUMMARY OF THE INVENTION

An objective of the present invention is to provide a scan method for a capacitive touch panel capable of suppressing noise and enhancing frame rate.

To achieve the foregoing objective, the scan method for a capacitive touch panel comprising steps of:

performing a first number of estimation scans on each of multiple sensing lines of a capacitive touch panel;

marking the sensing lines that comply with a predetermined condition according to results of the estimation scans; and

performing a second number of practical scans on each marked sensing line, wherein the second number is greater than the first number.

The present invention performs a relatively small first number of estimation scans to swiftly scan the touch panel, determines possibly existing touch objects on the touch panel, and marks the corresponding sensing lines in a first stage. The present invention then performs a relatively large second number of practical scans on the marked sensing lines in a second stage, and lowers the interference arising from noises with the higher number of practical scans and an average of the practical scans to ensure accurate scans. As the practical scans in the second stage are performed on part of the sensing lines and the number of the estimation scans in the first stage is relatively small, the present invention can significantly shorten the frame generation time and therefore increase the frame rate in contrast to conventional scan methods requiring to perform more scans on all the sensing lines.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of a scan method for a capacitive touch panel in accordance with the present invention;

FIG. 2 a flow diagram of the scan method in FIG. 1 applied to the self-capacitance sensing approach;

FIG. 3 a flow diagram of the scan method in FIG. 1 applied to the mutual-capacitance sensing approach;

FIG. 4 is a schematic view of a frame scanned by the scan method in FIG. 2 using a single-frame scanning scheme;

FIG. 5 is a schematic view of a frame scanned by a first embodiment of the scan method in FIG. 2 using a dual-frame scanning scheme;

FIG. 6 is a schematic view of a frame scanned by a second embodiment of the scan method in FIG. 2 using a dual-frame scanning scheme;

FIG. 7 is a schematic view of a frame scanned by the scan method in FIG. 3 using a single-frame scanning scheme;

FIG. 8 is a schematic view of a frame scanned by a first embodiment of the scan method in FIG. 3 using a dual-frame scanning scheme;

FIG. 9 is a schematic view of a frame scanned by a second embodiment of the scan method in FIG. 3 using a dual-frame scanning scheme;

FIG. 10 is a schematic view of a frame scanned by a conventional scan method applied to the self-capacitance sensing approach; and

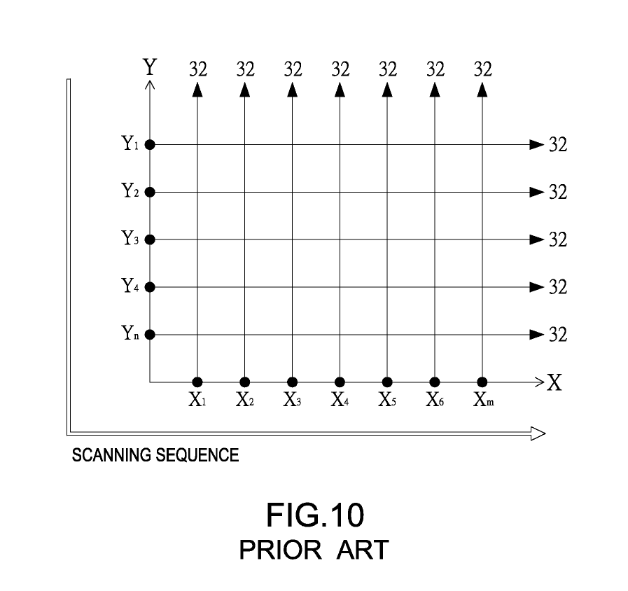

FIG. 11 is a schematic view of a frame scanned by a conventional scan method applied to the mutual-capacitance sensing approach.

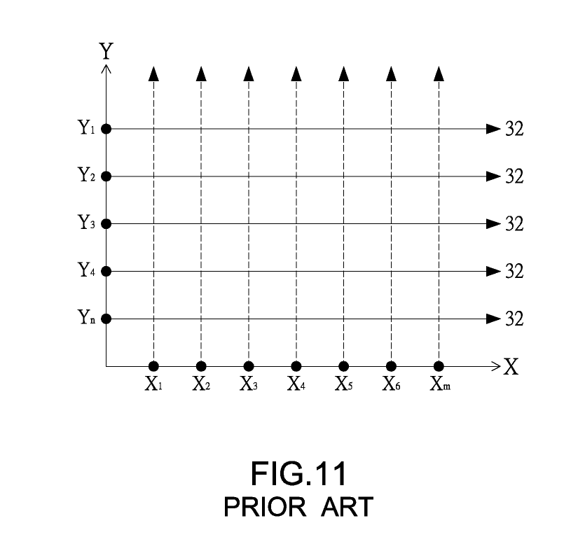

### DETAILED DESCRIPTION OF THE INVENTION

The present invention relates to a scan method capable of increasing frame rate of capacitive touch panels. No matter whether the self-capacitance sensing approach or the mutual-capacitance sensing approach is employed, the frame rate of capacitive touch panels can be effectively enhanced.

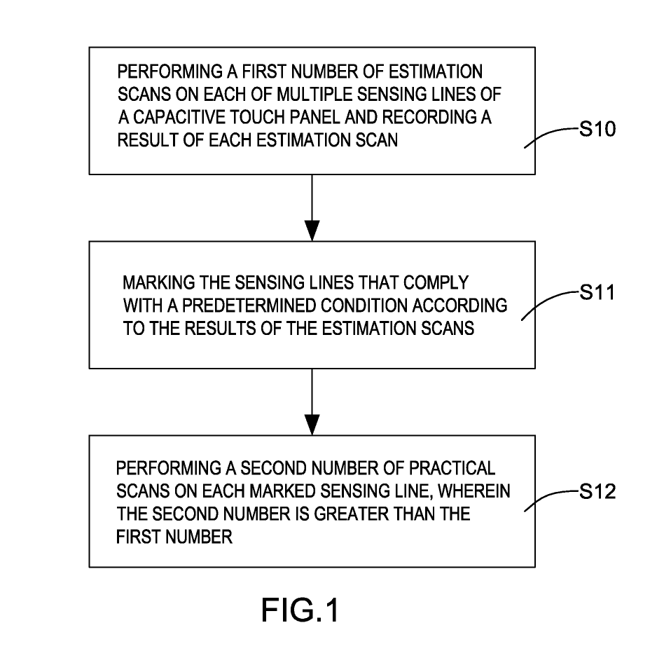

With reference to FIG. 1, a scan method in accordance with the present invention has the following steps.

Step S10: Perform a first number of estimation scans on each of multiple sensing lines of a capacitive touch panel and record a result of each estimation scan.

Step S11: Mark the sensing lines that comply with a predetermined condition according to the results of the estimation scans.

Step S12: Perform a second number of practical scans on each marked sensing line, wherein the second number is greater than the first number.

When implemented according to the foregoing steps, the scan method of the present invention is applicable to both the self-capacitance sensing approach and the mutual-capacitance sensing approach. The procedures of the scan method associated with the two approaches are described as follows.

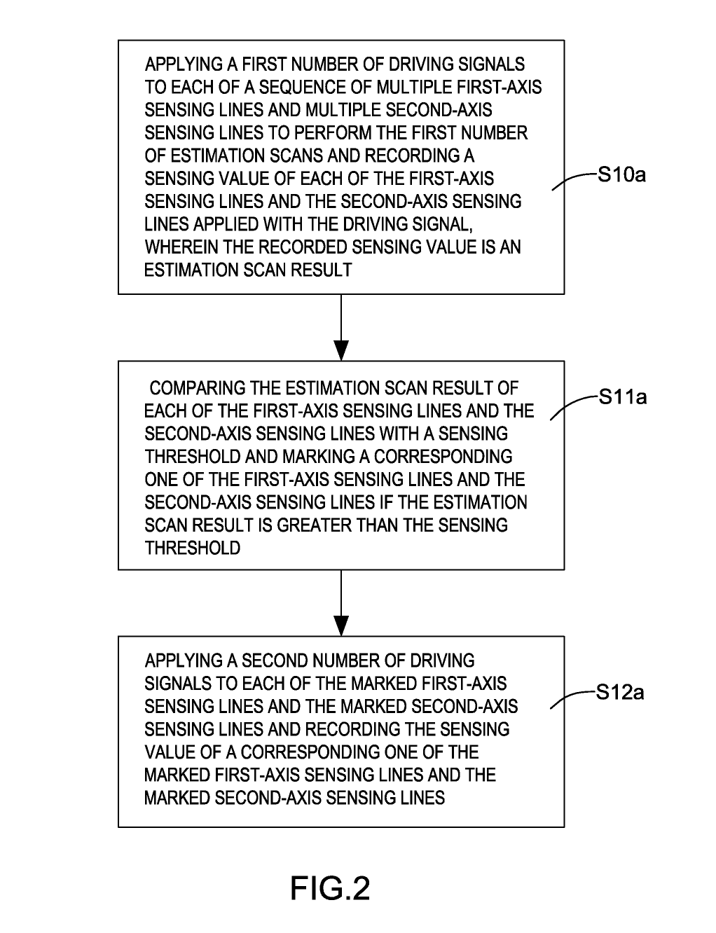

With reference to FIG. 2, the scan method applied to the self-capacitance sensing approach has the following steps.

During the foregoing step S10, apply a first number of driving signals to each of a sequence of multiple first-axis sensing lines and multiple second-axis sensing lines to perform the first number of estimation scans and record a sensing value of each of the first-axis sensing lines and the second-axis sensing lines applied with the driving signal S10a, wherein the recorded sensing value is an estimation scan result.

During the foregoing step S11, compare the estimation scan result of each of the first-axis sensing lines and the second-axis sensing lines with a sensing threshold and mark a corresponding one of the first-axis sensing lines and the second-axis sensing lines if the estimation scan result is greater than the sensing threshold S11a.

During the foregoing step S12, apply a second number of driving signals to each of the marked first-axis sensing lines and the marked second-axis sensing lines and record the sensing value of a corresponding one of the marked first-axis sensing lines and the marked second-axis sensing lines S12a, wherein the recorded sensing values are practical scan results serving as output frame data scanned by the self-capacitance sensing approach for identification of touch objects.

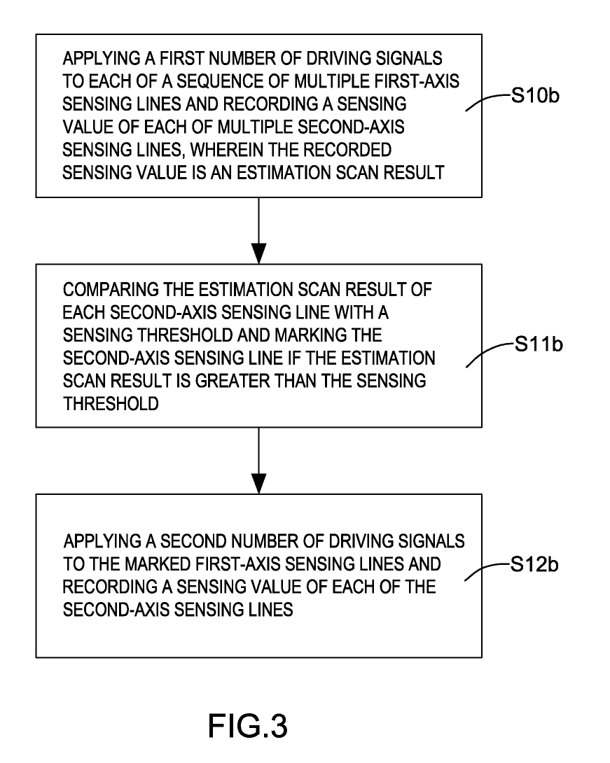

With reference to FIG. 3, the scan method applied to the mutual-capacitance sensing approach has the following steps.

During the foregoing step S10, apply a first number of driving signals to each of a sequence of multiple first-axis sensing lines and record a sensing value of each of multiple second-axis sensing lines S10b, wherein the recorded sensing value is an estimation scan result.

During the foregoing step S11, compare the estimation scan result of each second-axis sensing line with a sensing threshold and mark the second-axis sensing line if the estimation scan result is greater than the sensing threshold S11B.

During the foregoing step S12, apply a second number of driving signals to the marked first-axis sensing lines and record a sensing value of each of the second-axis sensing lines S12b, wherein the recorded sensing values are practical scan results serving as output frame data scanned by the mutual-capacitance sensing approach for identification of touch objects.

No matter if the self-capacitance sensing approach or the mutual-capacitance sensing approach is used, each approach can be further classified as a single-frame scanning scheme and a dual-frame scanning scheme according to the time spent on an estimation scan and a practical scan. These two schemes are explained with practical examples as follows.

A. Self-Capacitance Sensing Approach—Single-Frame Scanning Scheme

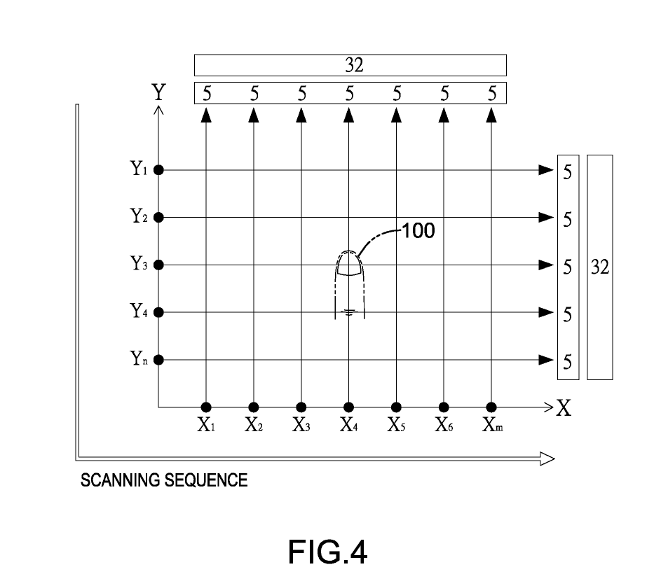

With reference to FIG. 4, given the self-capacitance sensing approach using a single-frame scanning scheme as an example, the Y-axis sensing lines are scanned first and then the X-axis sensing lines are scanned. Suppose that a count of estimation scan is set to be 5 times and a count of practical scan is set to be 32 times. Practically, each Y-axis sensing line Y₁˜Yₙ is scanned 5 times first, and then each sensing value scanned in the 5 times is determined if it is greater than a sensing threshold. The determination can be performed by taking an average of the sensing values scanned in the 5 times and comparing the average value with the sensing threshold, and if the average is greater than the sensing threshold, the sensing line may be touched by a touch object 100 and should be marked. Alternatively, if any of the sensing values scanned in the 5 times is greater than the sensing threshold, the sensing line may be also touched by the touch object 100. For example, if the sensing line Y₃ may be touched by a finger, 32 times of practical scans are further performed on the sensing line Y₃, and the practical scan results are recorded to determine if the sensing line Y₃ is touched by the finger. After the practical scans performed on the sensing line Y₃ are completed, the estimation scans are performed on the next sensing line Y₄. All the Y-axis sensing lines and the X-axis sensing lines are scanned in a similar fashion to obtain the sensed data of a complete frame scanned by the self-capacitance sensing approach for determining the existence of the touch object 100.

B. Mutual-Capacitance Sensing Approach—Dual-Frame Scanning Scheme

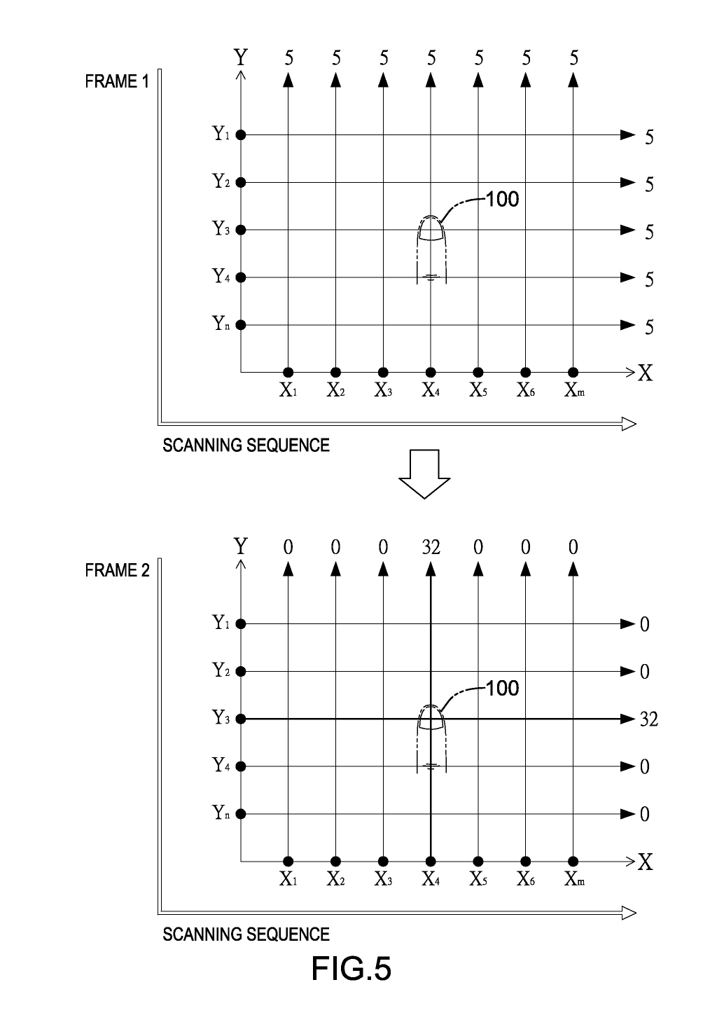

With reference to FIG. 5, given a first embodiment associated with the self-capacitance sensing approach using a dual-frame scanning scheme as an example, the Y-axis sensing lines are scanned first and then the X-axis sensing lines are scanned. Suppose that the count of estimation scan is set be 5 times and the count of practical scan is set to be 32 times. Practically, the steps of performing estimation scan and marking sensing line take place during a frame 1. In other words, each of the Y-axis sensing lines Y₁˜Yₙ and the X-axis sensing lines X₁˜Xₘ is scanned 5 times first, the sensing value of each of the Y-axis sensing lines and the X-axis sensing lines is determined if it is greater than a sensing threshold, and if the sensing value is greater than the sensing threshold, a corresponding one of the Y-axis sensing lines and the X-axis sensing lines is marked. Hence, the output results of the frame 1 can identify the Y-axis sensing lines and the X-axis sensing lines to be marked. During a frame 2, all marked Y-axis sensing lines and the X-axis sensing lines are scanned 32 times to obtain the practical scan results for determining the availability of the touch object 100.

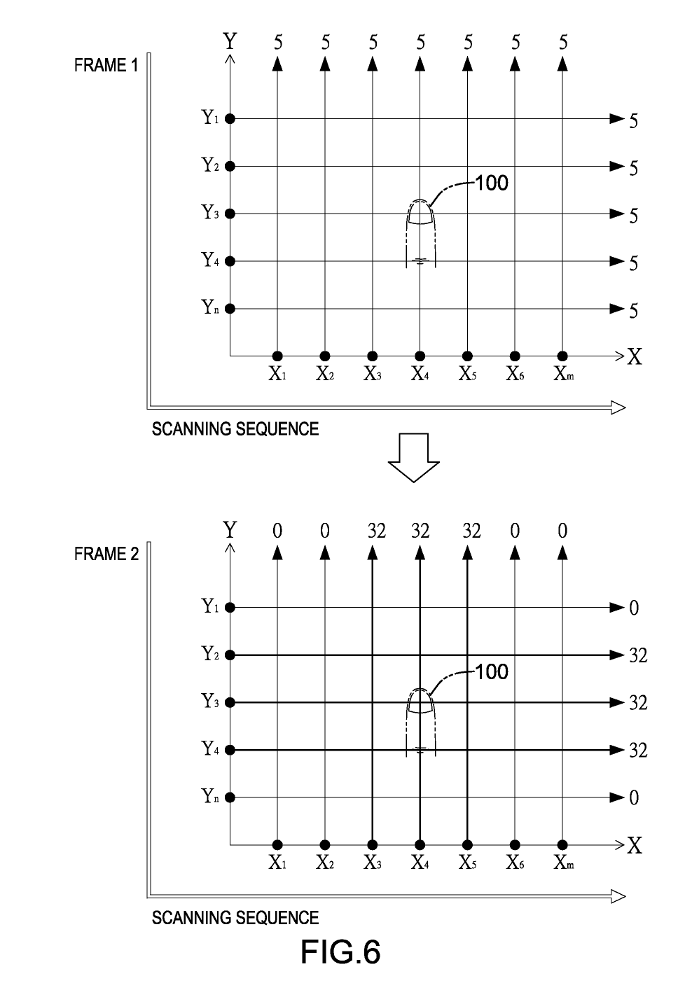

With reference to FIG. 6, a second embodiment associated with the self-capacitance sensing approach using a dual-frame scanning scheme is given to enhance the scanning linearity. When the estimation scans are performed on the frame 1, if the sensing value of any of the Y-axis sensing lines and the X-axis sensing lines is greater than the sensing threshold, the two co-axial sensing lines next to a corresponding one of the Y-axis sensing lines and the X-axis sensing lines are also marked. For example, if the sensing value of the N^{th} sensing line is greater than the sensing threshold, the co-axial (N−1)^{th} sensing line and (N+1)^{th} sensing line are also marked. During the frame 2, practical scans are performed 32 times on each of the marked sensing lines to enhance the scanning linearity. With further reference to FIG. 6, the X-axis sensing line X4 and the X-axis sensing lines X3 and X5 next to X4 as well as the Y-axis sensing line Y3 and the Y-axis sensing lines Y2 and Y4 next to Y3 are all marked for the practical scans to be performed thereon in the frame 2.

C. Mutual-Capacitance Sensing Approach—Single-Frame Scanning Scheme

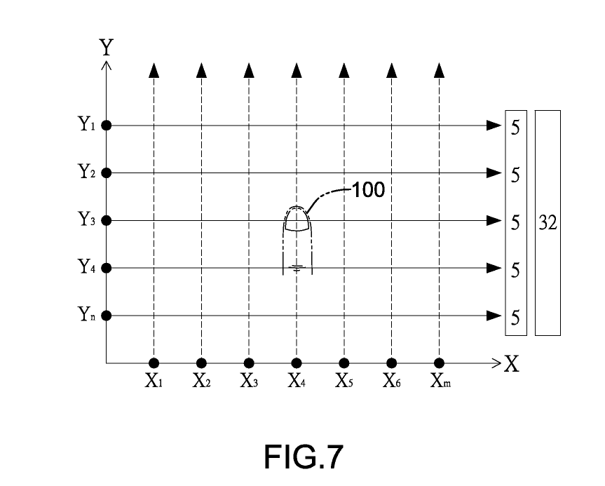

With reference to FIG. 7, given the scan method applied to the mutual-capacitance sensing approach as an example, suppose that the driving signals are applied to the Y-axis sensing lines and the X-axis sensing lines are sensed. Suppose that the count of estimation scan is set to be 5 times and the count of practical scan is set to be 32 times. Practically, each Y-axis sensing line Y₁˜Yₙ is scanned 5 times first and then each X-axis sensing line X₁˜Xₘ is sensed. The sensing value of each X-axis sensing line X₁˜Xₘ is compared with a sensing threshold, and if the sensing value is greater than the sensing threshold, it represents that a corresponding Y-axis sensing line may be touched by the touch object 100 and is thus marked. For example, if the Y-axis sensing line Y₃ may be touched by a touch object, the sensing values of the X-axis sensing lines are greater than the sensing threshold. The marked Y-axis sensing line Y₃ is further scanned 32 times and the practical scan results on each X-axis sensing line X₁˜Xₘ are recorded. When the practical scans performed on the Y-axis sensing line Y₃ are completed, the estimation scans are performed on next Y-axis sensing line Y₄. All the Y-axis sensing lines Y₁˜Yₙ are scanned in a similar fashion to obtain the sensed data of a complete frame scanned by the mutual-capacitance sensing approach.

D. Mutual-Capacitance Scanning Approach—Dual-Frame Scanning Scheme

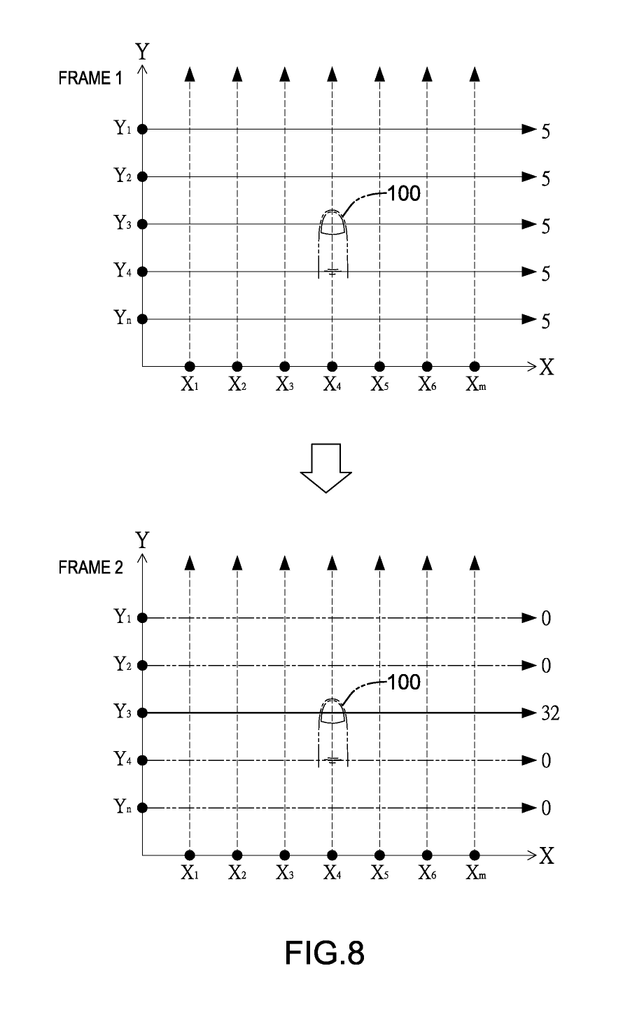

With reference to FIG. 8, given a first embodiment associated with the mutual-capacitance sensing approach using a dual-frame scanning scheme as an example, the Y-axis sensing lines are applied with the driving signals first and then the X-axis sensing lines are scanned. Suppose that the count of estimation scan is set to be 5 times and the count of practical scan is set to be 32 times. Practically, the steps of performing estimation scan and marking sensing line take place during a frame 1. Each Y-axis sensing line Y₁˜Y₁ is applied with the driving signal 5 times first. When any of the Y-axis sensing lines is scanned, each X-axis sensing line X₁˜Xₘ is sensed. The sensing value of each X-axis sensing line X₁˜Xₘ is compared with a sensing threshold, and if the sensing value is greater than the sensing threshold, it represents that the Y-axis sensing line may be touched by a touch object 100 and should be marked. After the estimation scans performed on each Y-axis sensing line are completed, the marked Y-axis sensing lines are recorded in completion of the steps performed in the frame 1. During a frame 2, the driving signal is applied to each marked Y-axis sensing line 32 times. When the marked Y-axis sensing lines are scanned, each X-axis sensing line X₁˜Xₘ is sensed so as to obtain the practical scan results for determining the availability of the touch object 100.

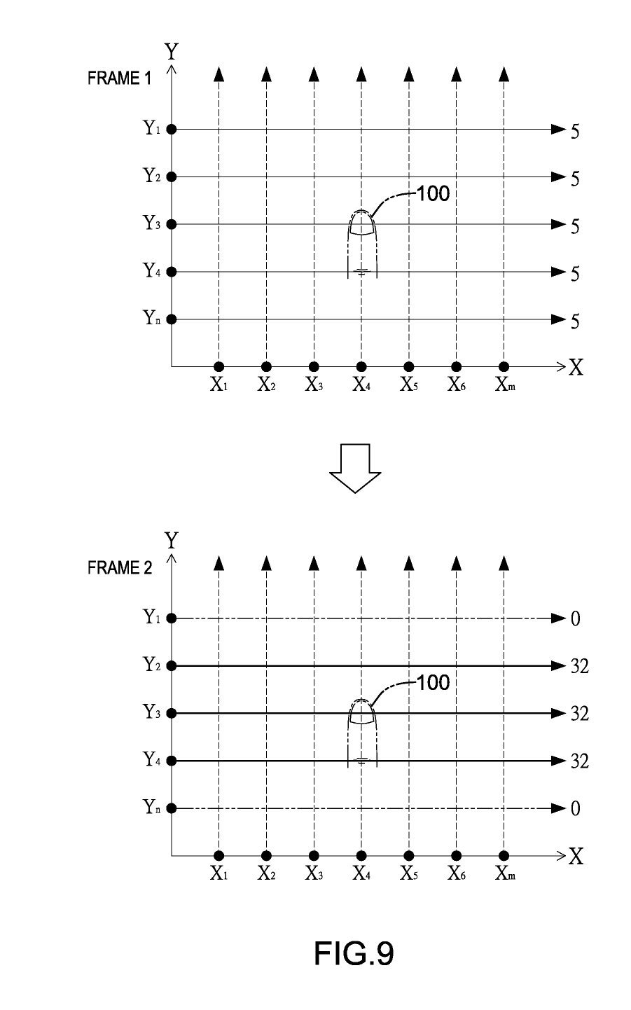

Likewise, with reference to FIG. 9, a second embodiment associated with the mutual-capacitance sensing approach using a dual-frame scanning scheme is given to enhance the scanning linearity. When the estimation scans are performed in the frame 1, if the sensing value of any of the Y-axis sensing lines is greater than the sensing threshold, the two other Y-axis sensing lines next to the Y-axis sensing line are also marked to expand a range of marked sensing lines. During the frame 2, the marked Y-axis sensing lines are applied with the driving signals to enhance the scanning linearity.

Given the estimation scan, the present invention can rapidly determine the possible existence of the touch object 100 on a touch panel with relatively fewer count of scans. Only a small fraction of the sensing lines are marked while more practical scans are performed on the marked sensing lines to reduce the interference caused by noise and enhance the accuracy for identifying touch objects. As the practical scans are performed on part of the sensing lines, the frame rate is significantly increased for sake of less time required to complete a frame.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A scan method for a capacitive touch panel comprising steps of:
performing a first number of estimation self-capacitance scans (k) on each of multiple sensing lines of a capacitive touch panel, wherein each of the multiple sensing lines are scanned by k times when the first number (k) of estimation self-capacitance scans are performed;
marking the sensing lines that comply with a predetermined condition according to results of the estimation self-capacitance scans; and
performing a second number (q) of practical self-capacitance scans on each marked sensing line, wherein each of the all marked sensing lines is scanned by q times after the second number (q) of practical self-capacitance scans are performed, wherein the second number is greater than the first number (q>k).

2. The scan method for a capacitive touch panel as claimed in claim 1, wherein
the sensing lines of the capacitive touch panel has multiple first-axis sensing lines and multiple second-axis sensing lines; and
in the step of performing a first number of estimation self-capacitance scans, the first number of estimation self-capacitance scans are performed on the first-axis sensing lines first and then on the second-axis sensing lines, a sensing value of each of the first-axis sensing lines and the second-axis sensing lines is recorded, wherein the recorded sensing value is an estimation self-capacitance scan result.

3. The scan method for a capacitive touch panel as claimed in claim 2, wherein in the step of marking the sensing lines, the estimation self-capacitance scan result of each of the first-axis sensing lines and the second-axis sensing lines is compared with a sensing threshold, and a corresponding one of the first-axis sensing lines and the second-axis sensing lines is marked if the estimation self-capacitance scan result is greater than the sensing threshold.

4. The scan method for a capacitive touch panel as claimed in claim 3, wherein in the step of performing a second number of practical self-capacitance scans, a second number of driving signals are applied to each of the marked first-axis sensing lines and the marked second-axis sensing lines, and the sensing value of a corresponding one of the marked first-axis sensing lines and the marked second-axis sensing lines is recorded, wherein the recorded sensing values are practical scan results serving as output frame data scanned for identification of touch objects after the step of performing a second number of practical self-capacitance scans is completed.

5. The scan method for a capacitive touch panel as claimed in claim 2, wherein when one of the sensing lines is marked, a second number of practical self-capacitance scans are performed on the marked sensing line, and after the practical self-capacitance scans are completed, the estimation self-capacitance scans are performed on the next sensing line until the estimation self-capacitance scans and the practical self-capacitance scans are performed on all the sensing lines in a single frame.

6. The scan method for a capacitive touch panel as claimed in claim 3, wherein when one of the sensing lines is marked, a second number of practical self-capacitance scans are performed on the marked sensing line, and after the practical self-capacitance scans are completed, the estimation self-capacitance scans are performed on the next sensing line until the estimation self-capacitance scans and the practical self-capacitance scans are performed on all the sensing lines in a single frame.

7. The scan method for a capacitive touch panel as claimed in claim 4, wherein when one of the sensing lines is marked, a second number of practical self-capacitance scans are performed on the marked sensing line, and after the practical self-capacitance scans are completed, the estimation self-capacitance scans are performed on the next sensing line until the estimation self-capacitance scans and the practical self-capacitance scans are performed on all the sensing lines in a single frame.

8. The scan method for a capacitive touch panel as claimed in claim 2, wherein the steps of performing a first number of estimation self-capacitance scans and marking the sensing lines are completed in a first frame, and the step of performing a second number of practical self-capacitance scans on each marked sensing line is completed in a second frame.

9. The scan method for a capacitive touch panel as claimed in claim 3, wherein the steps of performing a first number of estimation self-capacitance scans and marking the sensing lines are completed in a first frame, and the step of performing a second number of practical self-capacitance scans on each marked sensing line is completed in a second frame.

10. The scan method for a capacitive touch panel as claimed in claim 4, wherein the steps of performing a first number of estimation self-capacitance scans and marking the sensing lines are completed in a first frame, and the step of performing a second number of practical self-capacitance scans on each marked sensing line is completed in a second frame.

11. The scan method for a capacitive touch panel as claimed in claim 8, wherein in the step of marking the sensing lines in the first frame, each sensing line determined to be marked and two of the co-axial sensing lines next thereto are all marked.

12. The scan method for a capacitive touch panel as claimed in claim 9, wherein in the step of marking the sensing lines in the first frame, each sensing line determined to be marked and two of the co-axial sensing lines next thereto are all marked.

13. The scan method for a capacitive touch panel as claimed in claim 10, wherein in the step of marking the sensing lines in the first frame, each sensing line determined to be marked and two of the co-axial sensing lines next thereto are all marked.
